(19) United States
(12) Patent Application Publication
(10) Pub. No.: US 2004/0253372 A1
(43) Pub. Date: Dec. 16, 2004

(54) Uniform coating process of metal powder micro thin film

(76) Inventor: Pei Choa Wang, Pingjhen City (TW)

Correspondence Address: HDSL, 4331 STEVENS BATTLE LANE, FAIRFAX, VA, 22033, US

(21) Appl. No.: 10/784,251

(22) Filed: Feb. 24, 2004

(30) Foreign Application Priority Data
Jun. 10, 2003 (TW) 092115727

(51) Int. Cl. B05D 1/12

(52) U.S. Cl. 427/180

(57) ABSTRACT

A uniform coating process of a powder metal micro thin film applies to a container with various shapes and a smooth interior bottom surface. A powder metal is mixed with a liquid to form a mixture. The mixture is filled in the container, which is then slightly vibrated allowing the mixture to evenly distribute on the interior bottom surface. The liquid is vaporized until the powder metal deposited on the bottom surface has a thickness less than 0.1 mm. Thereby, a thin film is formed with a simple process and low cost.

### BACKGROUND OF THE INVENTION

The present invention relates in general to a coating process of a heat dissipating thin film, and more particularly, to a uniform coating process for a metal micro thin film

The wick structure has been used as a heat dissipation layer in a heat pipe. A working fluid is vaporized by absorbing heat in the evaporator section of the heat pipe, and is condensed by dissipation of thermal energy in the condenser section of the heat pipe. When the working fluid is condensed in the heat pipe, the capillary force of the wicking structure allows the working fluid to flow back to the heat absorption section. FIG. 1 illustrates the application of the wick structure. The container 1a carries the conventional wick structure 2a and accommodate a support member 3a therein to achieve heat dissipation as described above. The process for fabricating the wick structure 2a normally includes grooving, fiber, screen mesh and sinter. Various structures and materials have been applied to achieve heat dissipation effect.

However, the trend of reducing product dimension greatly demands a heat dissipation device with higher thermal conductivity and smaller size. However, size reduction and efficiency of above fabrication process is very limited. Further, the conventional process requires tedious processes and tools, such that the cost of the conventional heat pipes is very high.

As the grooving, fiber and screen mesh processes cannot overcome the gravitation, weaker capillary force is resulted. The sintering process, though provides porosity characteristic to increase surface area, cannot be formed thinner. Therefore, there is a substantial need to develop a new heat dissipation structure with a thinner dimension and an improved heat dissipation efficiency.

### SUMMARY OF THE INVENTION

The present invention provides a uniform coating process for a metal micro thin film. The micro thin film can be fabricated with a thinner dimension and improved performance in heat dissipation. Further, the process is simple and easily performed, such that the cost is lowered.

The coating process provided by the present invention is applied to a container with a smooth bottom surface and an any profile. The process includes the following steps. Powder-like metal is added into a solution to form an alkaline metal powder mixture. The mixture is stirred evenly and filled into the container. The mixture is then vaporized until a metal deposit film formed on the bottom surface of the container has a thickness no thicker than about 0.1 mm. Thereby, the metal thin film is formed by simple process with low cost.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF ACCOMPANIED DRAWINGS

The above objects and advantages of the present invention will be become more apparent by describing in detail exemplary embodiments thereof with reference to the attached drawings in which:

FIG. 1 illustrates a conventional wick structure;

FIG. 2 is a flow chart showing the processing of forming a metal micro thin film;

FIG. 3 is a macroscopic view of the metal micro thin film;

FIG. 3A is a local enlargement of FIG. 3; and

FIG. 4 shows another embodiment of fabricating a metal micro thin film

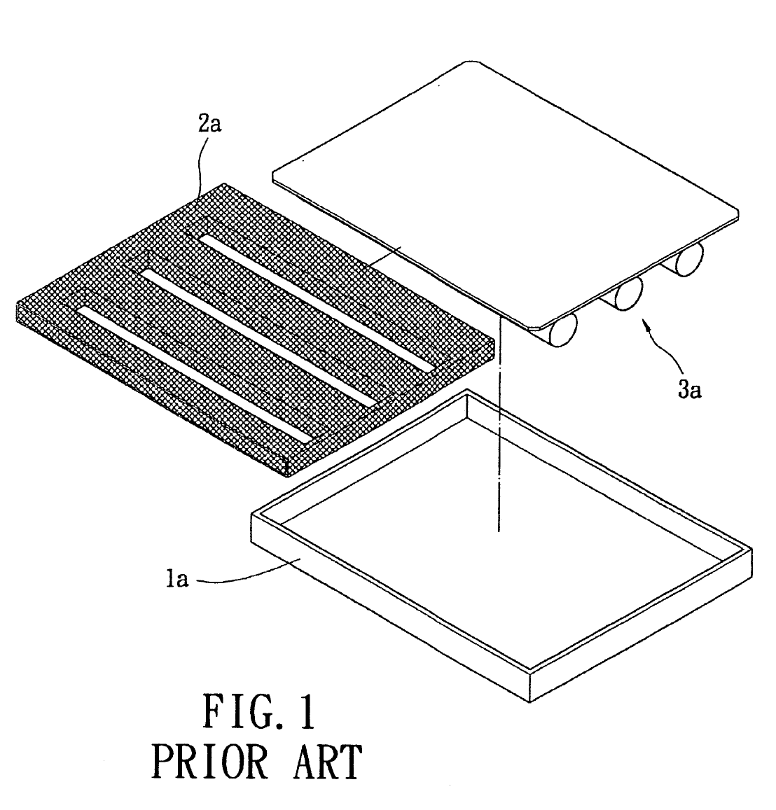

### DETAILED DESCRIPTION OF EMBODIMENT

Reference will now be made in detail to the preferred embodiments of the present invention, examples of which are illustrated in the accompanying drawings. Wherever possible, the same reference numbers are used in the drawings and the description to refer to the same or like parts.

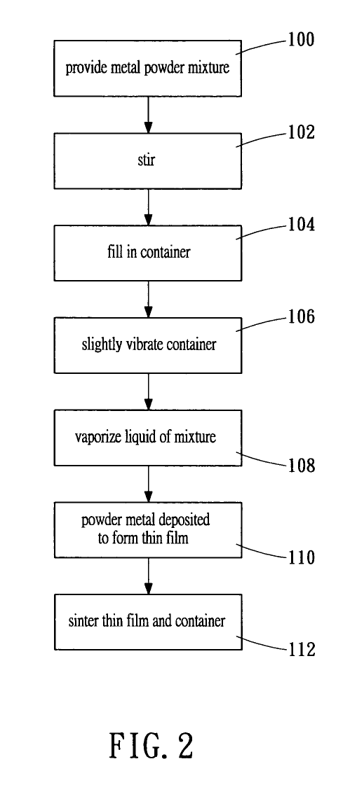

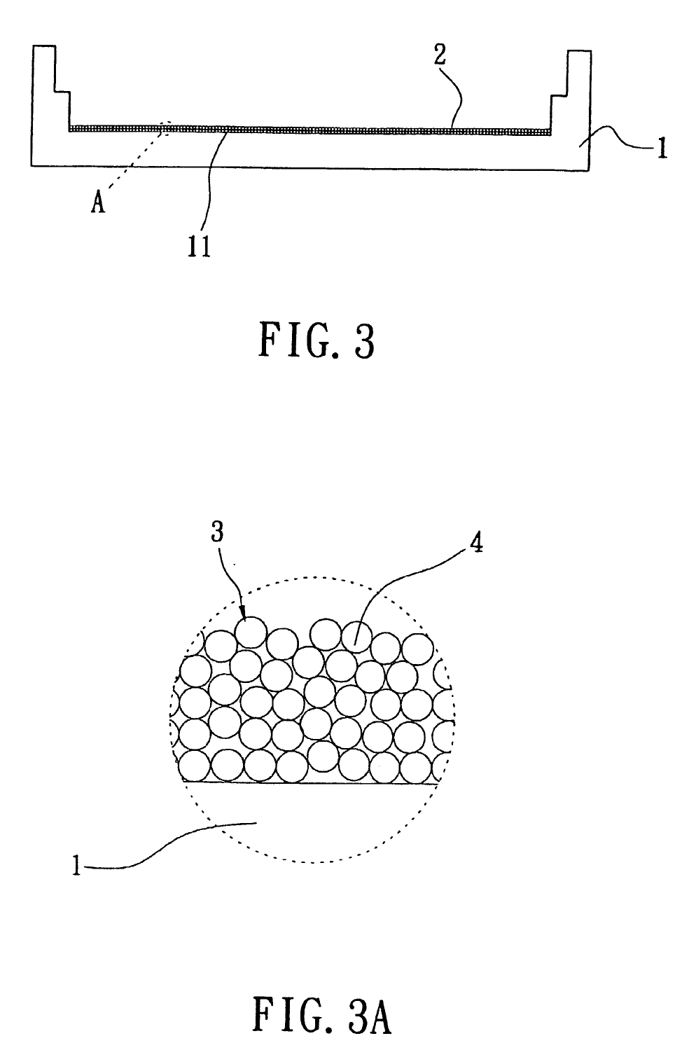

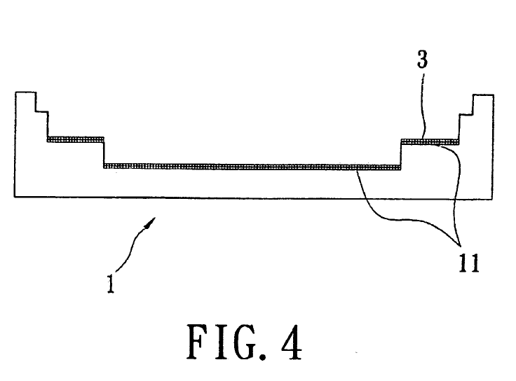

As shown in FIGS. 2, 3, 3A and 4, the present invention provides a uniform coating process of a metal micro thin film. As shown, a predetermined amount of power metal 4 and a predetermined amount of liquid solution are mixed to form a metal powder mixture 2 in step 100. The powder metal 4 includes copper powder, and the solution includes pure water. The metal powder mixture 2 must have a density to be advantageous in flow fluency. The mixture 42 is stirred in step 102, such that the viscosity and latent heat of the mixture can reach predetermined values. In step 104, the metal powder mixture 2 is filled in the container 1 which has any profile and a smooth bottom surface 11. The profile includes rectangle, circle, oval and triangle, for example. The container 106 is then slightly vibrated in step 106, such that the mixture 2 is uniformly distributed in the interior surface 11 of the container 1 (as shown in FIG. 3). The container 1 may provides a plurality of interior surfaces 11 in a stair-like configuration as shown in FIG. 4. The liquid of the mixture 2 is then vaporized in step 108, such that the powder metal 4 is deposited on the interior bottom surface 11 with a thickness less than about 0.1 mm in step 110. The deposit powder metal 4 thus forms a thin film 3 as shown in FIGS. 3 and 3A. A sintering step is then performed on both the thin film 3 and the container 1 to increase the density and attachment of the thin film 3.

By the sintering process, porosity is formed on the surface of the powder metal 4, such that the surface area of the thin film is increased. When the working fluid flows through the surface of the thin film, the unevenness of the thin film alleviates the surface tension the working fluid in contact with the thin film. Therefore, the coherence of the working fluid is larger than the surface tension to disperse into small molecules, such that the working fluid is more easily vaporized.

Therefore, the thin film increases the surface area, and the porosity formed therein provides more efficient vaporization of the working fluid, such that the working fluid delivers more thermal energy to provide more efficient heat dissipation.

The method of uniformize the powder metal 4 is not limited to a specific step. The thickness of the powder metal thin film 4 is preferably maintained under 0.1 mm.

In this invention, the powder metal mixture 2 is uniformly coated on the bottom surface 11 of the container, and simple processes such as stirring 102, vibration 106 and vaporization 108 are performed to obtain the highly efficient product.

While the present invention has been particularly shown and described with reference to preferred embodiments thereof, it will be understood by those of ordinary skill in the art the various changes in form and details may be made therein without departing from the spirit and scope of the present invention as defined by the appended claims.

What is claimed is:

1. A coating process of a powder metal micro thin film, suitable for use in a container in any profile and having at least one smooth interior bottom surface, the process comprising:
mixing a predetermined amount of powder metal with a predetermined amount of liquid to form a powder metal mixture, wherein the amounts of powder metal and liquid are adjusted to allow fluent flow of the powder metal mixture;
stirring the powder metal mixture;
filling the powder metal mixture in the container;
vibrating the container;
vaporizing liquid of the powder metal mixture; and
forming a thin film of powder metal deposited on the interior bottom surface of the container, wherein the thin film is thinner than about 0.1 mm.

2. The process as claimed in claim 1, wherein the container comprises one interior bottom surface.

3. The process as claimed in claim 1, wherein the container comprises a plurality of interior bottom surfaces arranged in a stair-like configuration.

4. The process as claimed in claim 1, wherein the powder metal includes copper powder.

5. The process as claimed in claim 1, wherein the liquid includes pure water.

6. The process as claimed in claim 1, further comprising performing a sintering process.
